(19) United States
(12) Patent Application Publication
(10) Pub. No.: US 2017/0230538 A1
(43) Pub. Date: Aug. 10, 2017

(54) IMAGE PROCESSING DEVICE, IMAGE PROCESSING METHOD, AND NON-TRANSITORY COMPUTER-READABLE MEDIUM

(71) Applicant: FUJI XEROX CO., LTD., Tokyo (JP)

(72) Inventor: Yusuke ONO, Kanagawa (JP)

(73) Assignee: FUJI XEROX CO., LTD., Tokyo (JP)

(21) Appl. No.: 15/223,398

(22) Filed: Jul. 29, 2016

(30) Foreign Application Priority Data
Feb. 10, 2016 (JP) 2016-023240

(51) Int. Cl. H04N 1/387; H04N 1/00; H04N 1/203

(52) U.S. Cl. CPC H04N 1/3876; H04N 1/3872; H04N 1/203; H04N 1/00013; H04N 1/00702; H04N 2201/0081; H04N 2201/0094

(57) ABSTRACT

An image processing device includes a classification unit that classifies a plurality of a first document image or a plurality of a second document image in accordance with an arrangement of documents, and a generation unit that generates an image in accordance with a result of the classification.

### CROSS-REFERENCE TO RELATED APPLICATIONS

This application is based on and claims priority under 35 USC 119 from Japanese Patent Application No. 2016-023240 filed Feb. 10, 2016.

### BACKGROUND

The present invention relates to an image processing device, an image processing method, and a non-transitory computer-readable medium.

### SUMMARY

According to an aspect of the invention, there is provided an image processing device including a classification unit that classifies a plurality of a first document image or a plurality of a second document image in accordance with an arrangement of documents, and a generation unit that generates an image in accordance with a result of the classification.

### BRIEF DESCRIPTION OF THE DRAWINGS

An exemplary embodiment of the present invention will be described in detail based on the following figures, wherein:

FIG. 1 is a schematic module configuration diagram for an exemplary configuration according to an exemplary embodiment;

FIG. 2 is an explanatory diagram illustrating an exemplary system configuration utilizing an exemplary embodiment;

FIGS. 3A to 3C are explanatory diagrams illustrating an exemplary process according to an exemplary embodiment;

FIGS. 4A and 4B are explanatory diagrams illustrating an example of a process according to an exemplary embodiment;

FIG. 5 is an explanatory diagram illustrating an exemplary data structure of a data table;

FIG. 6 is an explanatory diagram illustrating an example of a process according to an exemplary embodiment;

FIGS. 7A to 7C are explanatory diagrams illustrating an example of a process according to an exemplary embodiment;

FIG. 8 is an explanatory diagram illustrating an example of a process according to an exemplary embodiment;

FIG. 9 is an explanatory diagram illustrating an exemplary data structure of a data table;

FIGS. 10A to 100 are explanatory diagrams illustrating an example of a process according to an exemplary embodiment;

FIG. 11 is an explanatory diagram illustrating an example of a process according to an exemplary embodiment;

FIG. 12 is a flowchart illustrating an example of a process according to an exemplary embodiment;

FIG. 13 is a flowchart illustrating an example of a process according to an exemplary embodiment;

FIG. 14 is a flowchart illustrating an example of a process according to an exemplary embodiment;

FIG. 15 is a flowchart illustrating an example of a process according to an exemplary embodiment;

FIG. 16 is a flowchart illustrating an example of a process according to an exemplary embodiment;

FIG. 17 is a flowchart illustrating an example of a process according to an exemplary embodiment;

FIGS. 18A to 18J are explanatory diagrams illustrating an example of a process according to an exemplary embodiment;

FIG. 19 is an explanatory diagram illustrating an example of a process according to an exemplary embodiment;

FIG. 20 is an explanatory diagram illustrating an example of a process according to an exemplary embodiment;

FIG. 21 is an explanatory diagram illustrating an example of a process according to an exemplary embodiment;

FIG. 22 is a flowchart illustrating an example of a process according to an exemplary embodiment;

FIG. 23 is an explanatory diagram illustrating an example of a process according to an exemplary embodiment;

FIG. 24 is an explanatory diagram illustrating an example of a process according to an exemplary embodiment;

FIG. 25 is an explanatory diagram illustrating an example of a process according to an exemplary embodiment; and

FIG. 26 is a block diagram illustrating an exemplary hardware configuration of a computer that realizes an exemplary embodiment.

### DETAILED DESCRIPTION

Hereinafter, an exemplary embodiment related to realizing the present invention will be described by way of example on the basis of the drawings.

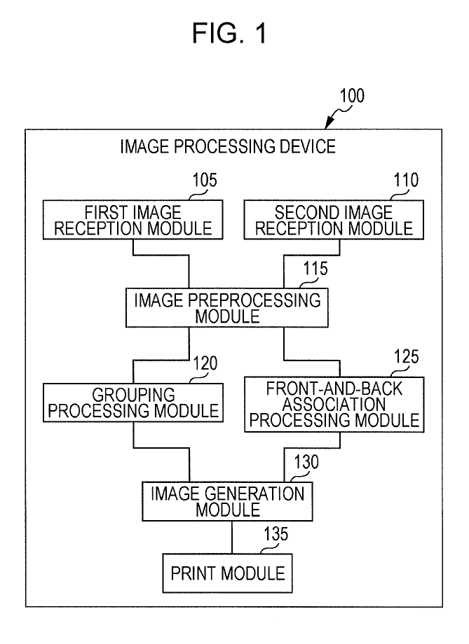

FIG. 1 illustrates a schematic module configuration for an exemplary configuration according to the exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, in accordance with conditions or states at that time, or in accordance with conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication link, and a register or the like inside a central processing unit (CPU).

The image processing device 100 according to the exemplary embodiment generates an image of a result of classifying document images. As illustrated in FIG. 1, the image processing device 100 includes a first image reception module 105, a second image reception module 110, an image preprocessing module 115, a grouping processing module 120, a front-and-back association processing module 125, an image generation module 130, and a print module 135. Additionally, the image processing device 100 may also associate an image of the front side of a document with an image of the back side of the document, and generate an image of a result of classifying the document images.

Herein, a document image refers to an image of a card-shaped document. The card-shaped document corresponds to documents such as an identification card (such as a Japan My Number card or a U.S. Social Security card, for example), a license, or a business card. Note that the document is not limited to being card-shaped, and it is sufficient to be able to use a scanner to scan in multiple documents as a single image.

Additionally, although the document has a front side and a back side, the “image of the reverse side of the document image” is not necessarily required to be an image of the back side, and may be an image of either the front side or the back side. However, in the example given the following description, although an image of the front side is used as the first document image and an image of the back side is used as the second document image (an image of the reverse side of the first document image), the images are not limited to such an example.

Printing the front side and the back side of a document on a single sheet is desirable in some cases, such as in the case of attaching documentation proving one's identity to an application form or the like. Obtaining an image of the front side and an image of the back side of a document usually involves two scans.

Furthermore, printing the front sides and the back sides of multiple documents on a single sheet is desirable in some cases, such as in the case of attaching identity documentation for all members of a family or other group to an application form or the like. In this case, if the front sides (or the back sides) of multiple documents are lined up and scanned, the work may be completed in two scans. In other words, instead of performing two scans for every single document, multiple documents may be scanned in by performing a total of two scans.

Additionally, scanning in the front sides and the back sides of multiple groups of documents in two scans is desirable in some cases. In other words, instead of performing two scans for every single group, multiple groups may be scanned in by performing a total of two scans. However, separating the document images by group is also desirable.

The image processing device 100 performs classification in accordance with the document arrangement. Herein, arrangement refers to the distances or the angles between documents when the operator lined up the documents. Note that “when the operator lined up the documents” is synonymous with “when the scanner scanned in the documents”, and furthermore is synonymous with the image scanned in by the scanner. For example, documents may be lined up collectively by group (with space in between groups), or the documents of one group may be lined up horizontally (landscape) while the documents of another group may be lined up vertically (portrait, that is, rotated 90 degrees from the landscape orientation).

The first image reception module 105 is connected to the image preprocessing module 115. The first image reception module 105 reads a first image of the front sides (or the back sides) of multiple documents.

The second image reception module 110 is connected to the image preprocessing module 115. The second image reception module 110 reads a second image of the back sides of multiple documents (the back sides in the case in which the first image reception module 105 reads in the front sides, or the front sides in the case in which the first image reception module 105 reads in the back sides).

Herein, the action of the first image reception module 105 and the second image reception module 110 receiving an image refers to, for example, reading an image with a device such as a scanner or camera, receiving an image from external equipment over a communication link via fax or the like, or loading an image stored on a device such as a hard disk (this includes devices built into a computer, as well as devices connected over a network). Images may be two-level (binary) images or multi-level images (including color images). The image to receive may be singular or plural. Additionally, it is sufficient for the content of the image to include multiple documents discussed above.

The image preprocessing module 115 is connected to the first image reception module 105, the second image reception module 110, the grouping processing module 120, and the front-and-back association processing module 125. The image preprocessing module 115 performs, on an image received by the first image reception module 105 or the second image reception module 110, image processing that serves as preprocessing in order to perform the processes by the grouping processing module 120 and the front-and-back association processing module 125. Hereinafter, document images included in the first image are designated the first document images, while document images included in the second image are designated the second document images.

The image preprocessing module 115 extracts multiple first document images from the first image. Additionally, the image preprocessing module 115 extracts multiple second document images from the second image obtained by reading the reverse sides of the multiple first document images.

In addition, the image preprocessing module 115 may also be configured to extract the distances between document images for the first document images and the second document images.

Additionally, the image preprocessing module 115 may also be configured to extract the tilt angles of the first document images and the second document images.

More specifically, as discussed later, the image preprocessing module 115 performs an image correction process such as noise removal with an image correction module 275, a process of extracting the edges of document images with an edge extraction module 265 (this corresponds to the process of extracting the document images), and a process of extracting features such as the position and angle of each document image with an edge recognition module 260.

The grouping processing module 120 is connected to the image preprocessing module 115 and the image generation module 130. The grouping processing module 120 classifies the multiple first document images received by the first image reception module 105 or the multiple second document images received by the second image reception module 110 in accordance with the document arrangement.

Note that the document images to be processed by the grouping processing module 120 may be either or both of the first document images in the first image and the second document images in the second image. In the case of processing both, if the classification result from processing the first document images is different from the classification result from processing the second document images, an indication that an error has occurred may also be presented. Obviously, if both classification results are the same, it is sufficient to perform the next process.

The grouping processing module 120 may also be configured to perform a classification process by treating the distances between document images extracted by the image preprocessing module 115 as the arrangement.

The grouping processing module 120 may also be configured to perform a classification process by treating the tilt angle of each document image extracted by the image preprocessing module 115 as the arrangement.

At this point, the process may also be performed two times using both the distances between the document images and the tilt angles of the document images as the arrangement handled by the grouping processing module 120. In other words, the document images are classified respectively using the above information, and if the classification results are different, an indication that an error has occurred may be presented. Obviously, if both classification results are the same, it is sufficient to perform the next process.

The front-and-back association processing module 125 is connected to the image preprocessing module 115 and the image generation module 130. The front-and-back association processing module 125 associates the first document images with the second document images, which are images of the reverse sides of the first document images.

The image generation module 130 is connected to the grouping processing module 120, the front-and-back association processing module 125, and the print module 135. The image generation module 130 generates an image in accordance with the result of the classification by the grouping processing module 120. The image generation module 130 may also be configured to generate an image in accordance with the result of the classification by the grouping processing module 120 and the result of the association by the front-and-back association processing module 125.

In addition, the image generation module 130 may also be configured to place the second document images next to the associated first document images, thereby enabling document images in the same class to be printed on the same sheet.

Note that the mode of placing document images and thereby “enabling document images in the same class to be printed on the same sheet” includes not only enabling all document images in the same class to be printed on a single sheet, but also enabling all document images in the same class to be printed on multiple sheets in cases where there are too many relevant document images to print on a single sheet. This also includes a mode of placing document images and thereby enabling document images of the same class to be printed on a single sheet. This is for attaching a set of grouped document images to an application form or the like as documentation proving identity or the like. Consequently, document images in the same class sometimes may be placed to enable printing on not only a single sheet but also multiple sheets, but on the other hand, document images in different classes are not included on a single sheet.

The image generation module 130 may also be configured to display the generated image and, by treating the combination of a first image and a second image in the display image as a single entity, change the position of the combination in accordance with operations by the operator.

The print module 135 is connected to the image generation module 130. The print module 135 prints an image generated by the image generation module 130.

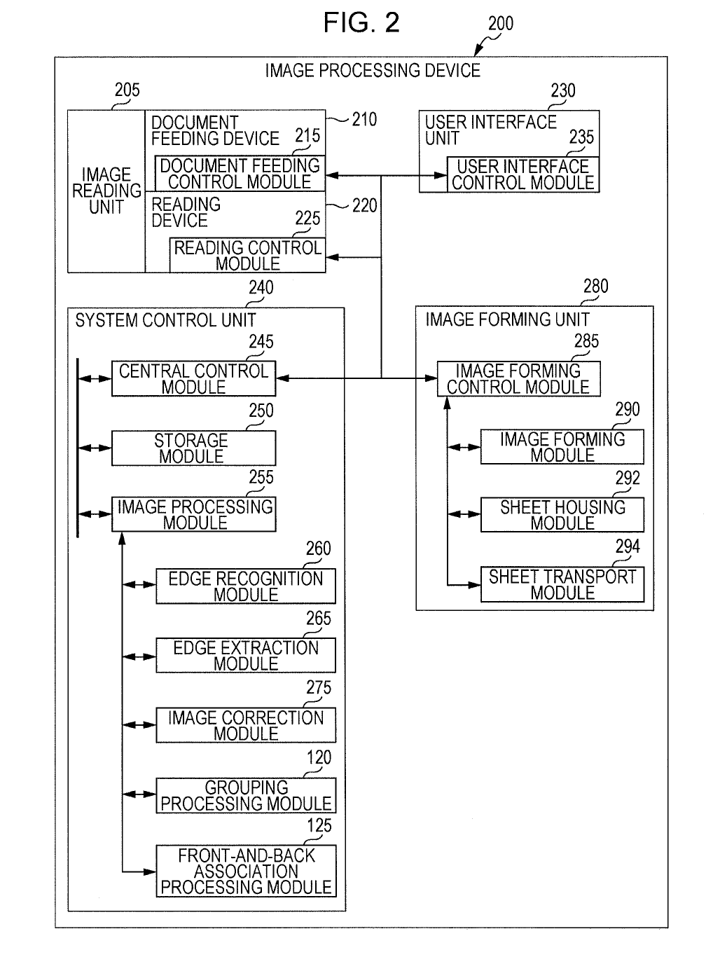

FIG. 2 is an explanatory diagram illustrating an exemplary system configuration utilizing an exemplary embodiment.

The image processing device 200 is a copier or a multi-function device (that is, an image processing device having two or more functions from among scanner, printer, copier, and fax machine functions) that incorporates the image processing device 100, and includes an image reading unit 205 that reads an image of a document, a user interface unit 230 that accepts operating input from a user and displays various information to the user, a system control unit 240 that controls the operation of the image processing device 200 as a whole, and an image forming unit 280 that forms an image onto a sheet.

The image reading unit 205 is a scanner, and includes a document feeding device 210 and a reading device 220.

The document feeding device 210 includes a document feeding control module 215. The document feeding device 210 is device for automatically feeding documents to read, enabling multiple pages of documents to be read.

The document feeding control module 215 is connected to a reading control module 225, a user interface control module 235, a central control module 245, and an image forming control module 285. The document feeding control module 215 causes the document feeding device 210 to feed documents according to an instruction from the central control module 245 or the like.

The reading device 220 includes the reading control module 225. The reading device 220 includes functions corresponding to the first image reception module 105 and the second image reception module 110 illustrated in the example of FIG. 1.

The reading control module 225 is connected to the document feeding control module 215, the user interface control module 235, the central control module 245, and the image forming control module 285. The reading control module 225 causes the reading device 220 to read a document according to an instruction from the central control module 245 or the like.

The user interface unit 230 includes the user interface control module 235. The user interface unit 230 also includes, for example, presentation devices like a display device such as a liquid crystal display and an audio output device such as a speaker, and operation receiving devices such as keys and a touch panel. Note that the user interface unit 230 may also be configured to receive user operations using input methods such as a mouse, a keyboard, speech, gaze, or gestures.

The user interface control module 235 is connected to the document feeding control module 215, the reading control module 225, the central control module 245, and the image forming control module 285. The user interface control module 235 causes the user interface unit 230 to present information according to an instruction from the central control module 245 or the like, and passes received operations to the central control module 245 or the like.

The system control unit 240 includes the central control module 245, a storage module 250, an image processing module 255, the edge recognition module 260, the edge extraction module 265, the image correction module 275, the grouping processing module 120, and the front-and-back association processing module 125.

The central control module 245 is connected to the storage module 250, the image processing module 255, the document feeding control module 215, the reading control module 225, the user interface control module 235, and the image forming control module 285. The central control module 245 controls the image reading unit 205, the user interface unit 230, and the image forming unit 280 in order to exhibit functionality as the image processing device 200.

The storage module 250 is connected to the central control module 245 and the image processing module 255. The storage module 250 includes memory, a hard disk, or the like, and stores information such as images and processing results from the image processing module 255.

The image processing module 255 is connected to the central control module 245, the storage module 250, the edge recognition module 260, the edge extraction module 265, the image correction module 275, the grouping processing module 120, and the front-and-back association processing module 125. The image processing module 255 controls components such as the edge recognition module 260 to process an image read by the image reading unit 205. Additionally, the image processing module 255 includes functions corresponding to the image generation module 130 illustrated in the example of FIG. 1.

The image correction module 275 is connected to the image processing module 255. The image correction module 275 performs correction processes such as noise removal and tilt correction on an image read by the image reading unit 205. These correction processes may use established technology.

The edge extraction module 265 is connected to the image processing module 255. The edge extraction module 265 extracts the edges of a document image in an image. The edge extraction process may use established technology. For example, the Sobel filter, which extracts portions where the density value of an image changes suddenly as edges, may be used.

The edge recognition module 260 is connected to the image processing module 255. The edge recognition module 260 extracts a rectangular image (card-shaped image) of predetermined size from the edges extracted by the edge extraction module 265.

The grouping processing module 120 is connected to the image processing module 255.

The front-and-back association processing module 125 is connected to the image processing module 255.

The image processing module 255, the edge recognition module 260, the edge extraction module 265, and the image correction module 275 include functions corresponding to the image preprocessing module 115 illustrated in the example of FIG. 1.

The image forming unit 280 is a printer, and includes the image forming control module 285, an image forming module 290, a sheet housing module 292, and a sheet transport module 294. The image forming unit 280 includes functions corresponding to the print module 135 illustrated in the example of FIG. 1.

The image forming control module 285 is connected to the image forming module 290, the sheet housing module 292, the sheet transport module 294, the document feeding control module 215, the reading control module 225, the user interface control module 235, and the central control module 245. The image forming control module 285 controls components such as the image forming module 290 to print an image onto a sheet (printout).

The image forming module 290 is connected to the image forming control module 285. The image forming module 290 prints an image generated by the image processing module 255 onto a sheet.

The sheet housing module 292 is connected to the image forming control module 285. The sheet housing module 292 houses and supplies sheets of paper or the like.

The sheet transport module 294 is connected to the image forming control module 285. The sheet transport module 294 transports a sheet from the sheet housing module 292 to the image forming module 290 for printing.

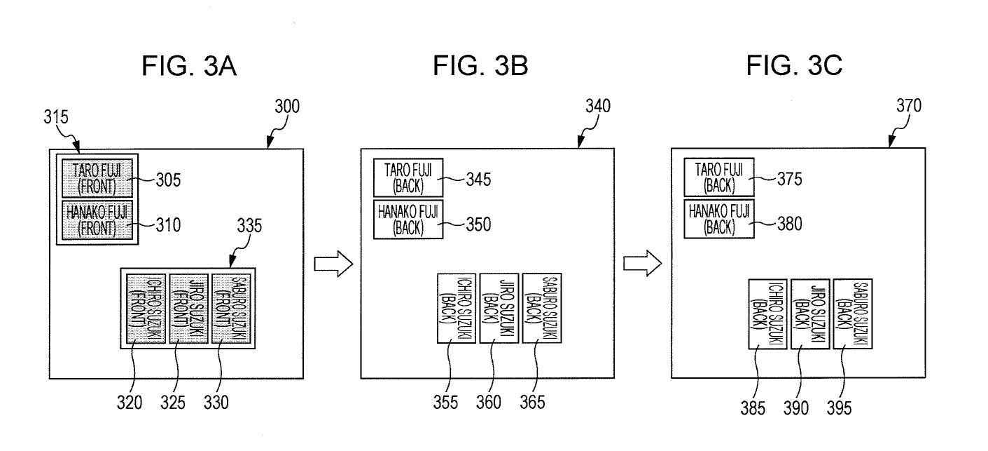

FIGS. 3A to 3C are explanatory diagrams illustrating an example of an overall process according to the present exemplary embodiment.

The image processing device 100 (image processing device 200) outputs multiple documents onto the same sheet. Additionally, at this point, by not restricting the positions where the user places the documents and not restricting the scan area, the number of documents on the output sheet is not restricted (obviously however, the number of documents is a number able to fit within the sheet size), and the number of steps involved in the user operations is fixed, irrespective of the number of groups to be recognized.

The example of FIG. 3A illustrates an image 300 that is read in by the first scan. The image 300 includes a card image (Taro Fuji (front)) 305, a card image (Hanako Fuji (front)) 310, a card image (Ichiro Suzuki (front)) 320, a card image (Jiro Suzuki (front)) 325, and a card image (Saburo Suzuki (front)) 330. At this point, the user places the documents so that the card image (Taro Fuji (front)) 305 and the card image (Hanako Fuji (front)) 310 are treated as a group A315, while the card image (Ichiro Suzuki (front)) 320, the card image (Jiro Suzuki (front)) 325, and the card image (Saburo Suzuki (front)) 330 are treated as a group B335. Namely, the card image (Taro Fuji (front)) 305 and the card image (Hanako Fuji (front)) 310 are oriented horizontally, whereas the card image (Ichiro Suzuki (front)) 320, the card image (Jiro Suzuki (front)) 325, and the card image (Saburo Suzuki (front)) 330 are oriented vertically.

First, the edge recognition module 260 obtains information for grouping. Subsequently, the grouping processing module 120 performs automatic grouping according to the acquired information. Herein, documents having an angle included within a certain range are treated as a group.

The example of FIG. 3B illustrates how documents are replaced. The user places a card (Taro Fuji (back)) 345, a card (Hanako Fuji (back)) 350, a card (Ichiro Suzuki (back)) 355, a card (Jiro Suzuki (back)) 360, and a card (Saburo Suzuki (back)) 365 on the document bed (also called the platen). In other words, each card is flipped over at the same position. Note that at this point, the scan area is taken to be the entire platen.

The example of FIG. 3C illustrates an image 370 that is read in by the second scan in the state illustrated in FIG. 3B. The image 370 includes a card image (Taro Fuji (back)) 375, a card image (Hanako Fuji (back)) 380, a card image (Ichiro Suzuki (back)) 385, a card image (Jiro Suzuki (back)) 390, and a card image (Saburo Suzuki (back)) 395. The front-and-back association processing module 125 compares the center coordinates of the front side and the back side of each card image, and respectively associates the front side images with the back side images.

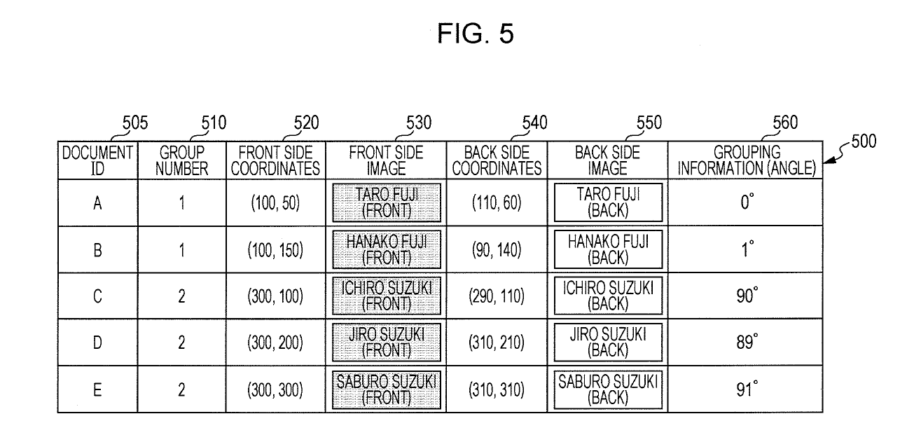

Subsequently, the group information, the front side images, and the back side images are registered in a data table 500, for example. FIG. 5 is an explanatory diagram illustrating an exemplary data structure of the data table 500. The data table 500 includes a document ID field 505, a group number field 510, a front side coordinates field 520, a front side image field 530, a back side coordinates field 540, a back side image field 550, and a grouping information (angle) field 560. The document ID field 505 stores an identification code for identifying a pair of document images (the front side image and the back side image of a card image) uniquely in the present exemplary embodiment. The group number field 510 stores a group number of the pair of document images. The front side coordinates field 520 stores the coordinates of the front side image, such as the center coordinates of the front side image, for example. The front side image field 530 stores the front side image. The front side image field 530 may store the front side image itself, or information such as the name of a file storing the front side image. The back side coordinates field 540 stores the coordinates of the back side image, such as the center coordinates of the back side image, for example. The back side image field 550 stores the back side image. The back side image field 550 may store the back side image itself, or information such as the name of a file storing the back side image. The grouping information (angle) field 560 stores information (an angle) utilized in the grouping process.

In the example of FIG. 5, the card image (Taro Fuji (front)) 305 and the card image (Taro Fuji (back)) 375 on the first row of the data table 500, and the card image (Hanako Fuji (front)) 310 and the card image (Hanako Fuji (back)) 380 on the second row, belong to a group 1 (group A315).

The card image (Ichiro Suzuki (front)) 320 and the card image (Ichiro Suzuki (back)) 385 on the third row of the data table 500, the card image (Jiro Suzuki (front)) 325 and the card image (Jiro Suzuki (back)) 390 on the fourth row, and the card image (Saburo Suzuki (front)) 330 and the card image (Saburo Suzuki (back)) 395 on the fifth row belong to a group 2 (group B335).

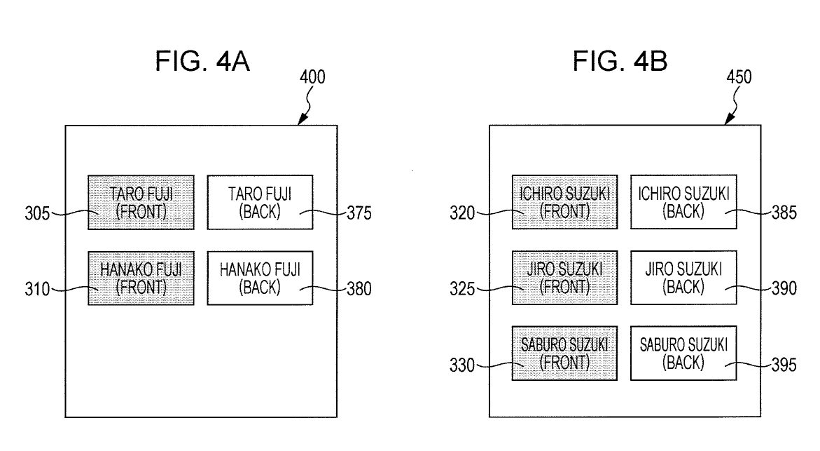

FIGS. 4A and 4B are explanatory diagrams illustrating an example of a process (an example of a printed result) according to the present exemplary embodiment. Herein, the card images are printed onto a different sheet for each group. In other words, front side images and back side images having the same group number are printed onto the same sheet.

In the example of FIG. 4A, the card image (Taro Fuji (front)) 305, the card image (Hanako Fuji (front)) 310, the card image (Taro Fuji (back)) 375, and the card image (Hanako Fuji (back)) 380 are printed on a sheet 400. The card image (Taro Fuji (back)) 375 is printed at a position adjacent to the card image (Taro Fuji (front)) 305, while the card image (Hanako Fuji (back)) 380 is printed at a position adjacent to the card image (Hanako Fuji (front)) 310.

In the example of FIG. 4B, the card image (Ichiro Suzuki (front)) 320, the card image (Jiro Suzuki (front)) 325, the card image (Saburo Suzuki (front)) 330, the card image (Ichiro Suzuki (back)) 385, the card image (Jiro Suzuki (back)) 390, and the card image (Saburo Suzuki (back)) 395 are printed on a sheet 450. The card image (Ichiro Suzuki (back)) 385 is printed at a position adjacent to the card image (Ichiro Suzuki (front)) 320, the card image (Jiro Suzuki (back)) 390 is printed at a position adjacent to the card image (Jiro Suzuki (front)) 325, and the card image (Saburo Suzuki (back)) 395 is printed at a position adjacent to the card image (Saburo Suzuki (front)) 330.

Note that the order in which the card images are arranged is taken to be the indexed number order (in order of closeness to the upper-left origin).

According to such a process by the image processing device 100, since the scan area is not restricted, it becomes possible to arrange a large number of documents, output a large number of documents onto the same sheet, and also recognize and output multiple groups with a single output instruction.

For the grouping algorithm, the grouping processing module 120 conducts <1> a grouping process using angle, or <2> a grouping process using distance.

### <1> Example of Grouping Process Using Angle

Before the processing, the following system data is set.

a) For the grouping algorithm (angle or distance), “angle” is set.
b) For the group determination angle (for example, a value within a range from 5° to 10° is preferable), 5° is adopted, for example.
c) For the front-and-back association determination length (for example, if the document is a license, a value within a range from 80 mm to 99 mm is preferable), 85 mm is adopted, for example.
d) For the front-and-back association determination width (for example, if the document is a license, a value within a range from 50 mm to 60 mm is preferable), 55 mm is adopted, for example.
(1) It is detected that the operator presses an “ID Card Copy” button on the user interface unit 230.
(2) A sheet size/document size settings screen is displayed on the display, and it is detected that the operator performs operations that set the sheet size to A4, and set the document to license.
(3) An instruction to arrange at a uniform angle the licenses that the operator wants to group is displayed on the display, and the operator arranges two licenses (Taro Fuji, Hanako Fuji) horizontally, and arranges another three (Ichiro Suzuki, Jiro Suzuki, Saburo Suzuki) vertically.
(4) It is detected that the operator presses a Start button.
(5) An instruction to flip over the documents is displayed on the display, and the operator flips over the documents in place. Subsequently, it is detected that the operator presses the Start button.
(6) The grouping process using the angles of the documents and the process of associating the front sides with the back sides are conducted, and printing is started.
(7) The printed results of the fronts and backs of the two licenses (the respective licenses of Taro Fuji and Hanako Fuji) and the fronts and backs of the three licenses (the respective licenses of Ichiro Suzuki, Jiro Suzuki, and Saburo Suzuki) are obtained on respectively separate sheets.

### <2> Example of Grouping Process Using Distance

Before the processing, the following system data is set.

a) For the grouping algorithm (angle or distance), “distance” is set.
b) For the group determination distance (for example, if the document is a license, a value from 110 mm to 120 mm is preferable), 110 mm is adopted, for example.
c) For the front-and-back association determination length (for example, if the document is a license, a value from 80 mm to 90 mm is preferable), 85 mm is adopted, for example.
d) For the front-and-back association determination width (for example, if the document is a license, a value from 50 mm to 60 mm is preferable), 55 mm is adopted, for example.
(1) It is detected that the operator presses an “ID Card Copy” button on the user interface unit 230.
(2) A sheet size/document size settings screen is displayed on the display, and it is detected that the operator performs operations that set the sheet size to A4, and set the document to license.
(3) An instruction to arrange closely the licenses that the operator wants to group is displayed on the display, and the operator arranges closely two licenses (Taro Fuji, Hanako Fuji), and arranges closely another three (Ichiro Suzuki, Jiro Suzuki, Saburo Suzuki).
(4) It is detected that the operator presses a Start button.
(5) An instruction to flip over the documents is displayed on the display, and the operator flips over the documents in place. Subsequently, it is detected that the operator presses the Start button.
(6) The grouping process using the distance between the documents and the process of associating the front sides with the back sides are conducted, and printing is started.
(7) The printed results of the fronts and backs of the two licenses (the respective licenses of Taro Fuji and Hanako Fuji) and the fronts and backs of the three licenses (the respective licenses of Ichiro Suzuki, Jiro Suzuki, and Saburo Suzuki) are obtained on respectively separate sheets.

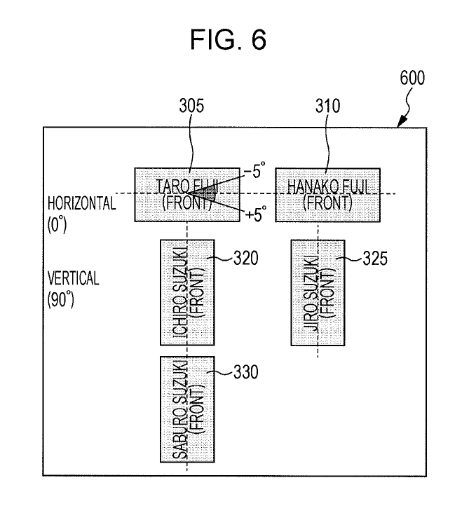

FIG. 6 is an explanatory diagram illustrating an example of a process (an example of an angle determination process) according to the present exemplary embodiment.

As discussed above, for the group determination angle (for example, a value within a range from 5° to 10° is preferable), suppose that 5° is set, for example.

### <Front Side Scan>

As a scanned result, the image 600 includes a card image (Taro Fuji (front)) 305, a card image (Hanako Fuji (front)) 310, a card image (Ichiro Suzuki (front)) 320, a card image (Jiro Suzuki (front)) 325, and a card image (Saburo Suzuki (front)) 330. In this case, the operator has arranged the card image (Taro Fuji (front)) 305 and the card image (Hanako Fuji (front)) 310 horizontally, and arranged the card image (Ichiro Suzuki (front)) 320, the card image (Jiro Suzuki (front)) 325, and the card image (Saburo Suzuki (front)) 330 vertically.

The center coordinates and the angles of all documents are extracted from the image 600 of the scan result. Note that, as illustrated in the example of FIG. 6, the “front side angle” is taken to be the angle obtained between a horizontal line and the long edge. The state in which the long edge is horizontal is taken to be 0°.

<Example of Grouping Process>

(1) The image having front side coordinates closest to the origin (for example, the upper-left) is taken to be the target.
(2) Grouping information for the targeted image is acquired.
(3) Records whose grouping information is included within the group determination angle are determined to be in the same group, and a group number is assigned.
(4) An image without an assigned group number is taken to be the target.
(5) Documents whose grouping information is included within the group determination angle are determined to be in the same group, and a group number is assigned.
(6) Thereafter, the processes of (4) and (5) are repeated until all documents are grouped.

<Practical Example of Grouping>

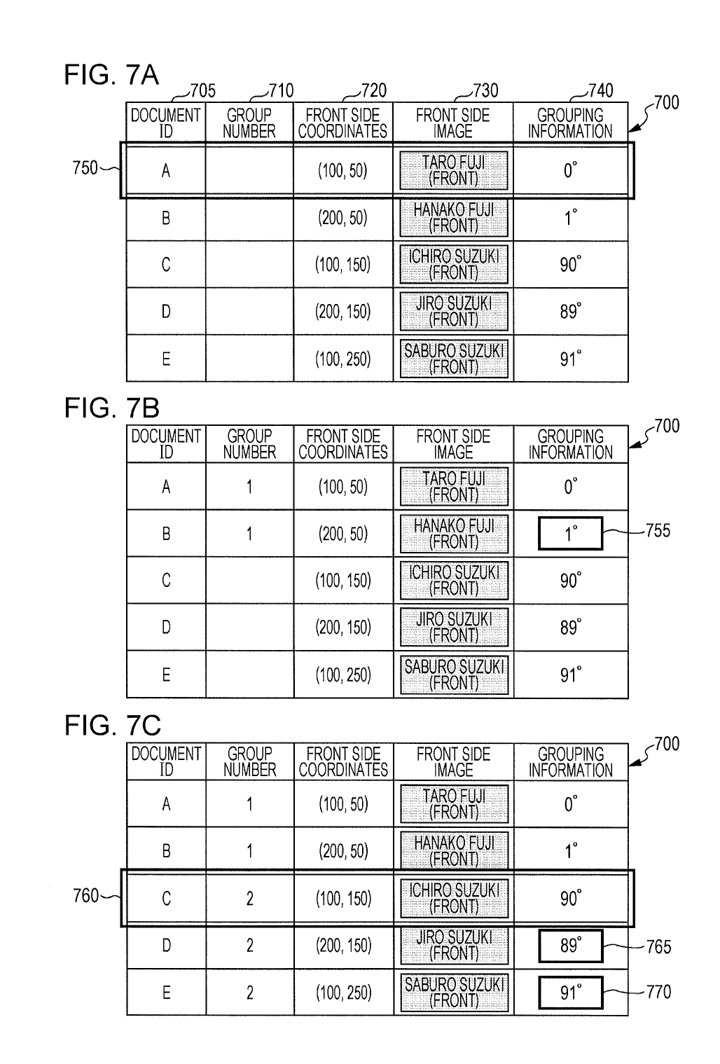

The example of FIGS. 7A to 7C will be used to explain in detail. Note that the data table 700 is a subset of the data table 500, and the document ID field 705, the group number field 710, the front side coordinates field 720, the front side image field 730, and the grouping information field 740 correspond to the document ID field 505, the group number field 510, the front side coordinates field 520, the front side image field 530, and the grouping information (angle) field 560, respectively.

(1) The record (processing target 750) having front side coordinates closest to the origin (for example, the upper-left) is taken to be the target (see FIG. 7A).
(2) Grouping information for the targeted record is acquired. In this example, the grouping information is “0°” (see FIG. 7A).
(3) Records whose grouping information is included within the group determination angle are determined to be in the same group, and a group number is assigned (see FIG. 7B). For the document ID B, the grouping information is “1°” (same group determination basis 755), for which the difference from the grouping information “0°” for the document ID A is less than or equal to the group determination angle (within +5° to −5°).
(4) A record without an assigned group number (processing target 760) is taken to be the target (see FIG. 7C).
(5) Records whose grouping information is included within the group determination angle are determined to be in a group, and a group number is assigned (see FIG. 7C). For the document IDs D and E, the grouping information is “89°” (same group determination basis 765) and “91°” (same group determination basis 770), respectively, for which the difference from the grouping information “90°” for the document ID C is less than or equal to the group determination angle (within +5° to −5°).

Consequently, the card image (Taro Fuji (front)) 305 and the card image (Hanako Fuji (front)) 310 become a group 1, while the card image (Ichiro Suzuki (front)) 320, the card image (Jiro Suzuki (front)) 325, and the card image (Saburo Suzuki (front)) 330 become a group 2.

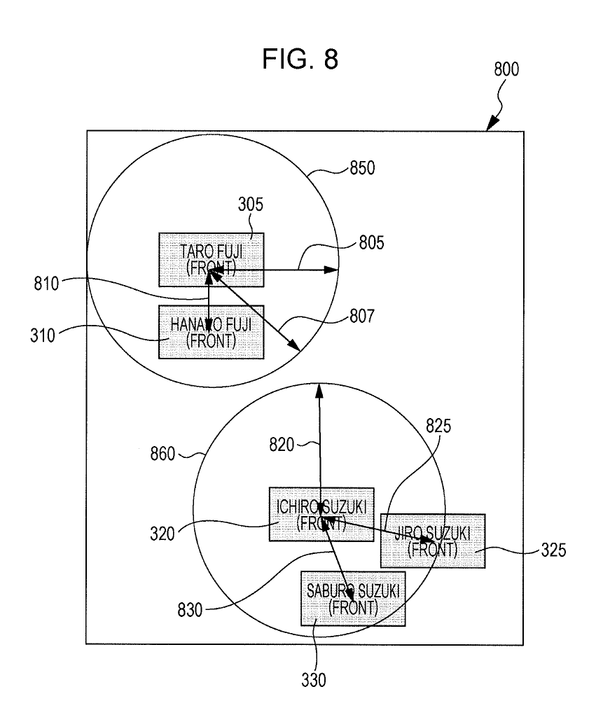

FIG. 8 is an explanatory diagram illustrating an example of a process (an example of a distance determination process) according to the present exemplary embodiment.

As discussed above, for the group determination distance (for example, if the document is a license, a value from 110 mm to 120 mm is preferable), suppose that 110 mm (group determination distances 805, 807, 820, 825, and 830) is set, for example.

### <Front Side Scan>

As a scanned result, the image 800 includes a card image (Taro Fuji (front)) 305, a card image (Hanako Fuji (front)) 310, a card image (Ichiro Suzuki (front)) 320, a card image (Jiro Suzuki (front)) 325, and a card image (Saburo Suzuki (front)) 330. In this case, the operator has arranged the card image (Taro Fuji (front)) 305 and the card image (Hanako Fuji (front)) 310 closely (within a group area 850), and arranged the card image (Ichiro Suzuki (front)) 320, the card image (Jiro Suzuki (front)) 325, and the card image (Saburo Suzuki (front)) 330 closely (within a group area 860).

The absolute coordinates of the centers of all documents are extracted from the image 800 of the scan result.

<Example of Grouping Process>

(1) The image having front side coordinates closest to the origin (for example, the upper-left) is taken to be the target.
(2) Grouping information for the targeted document (relative distances to the other documents) is computed.
(3) Documents whose grouping information is included within the group determination distance are determined to be in the same group, and a group number is assigned.
(4) A document without an assigned group number is taken to be the target.
(5) Grouping information is computed, documents whose grouping information is included within the group determination distance are determined to be in the same group, and a group number is assigned.
(6) Thereafter, the processes of (4) and (5) are repeated until all documents are grouped.

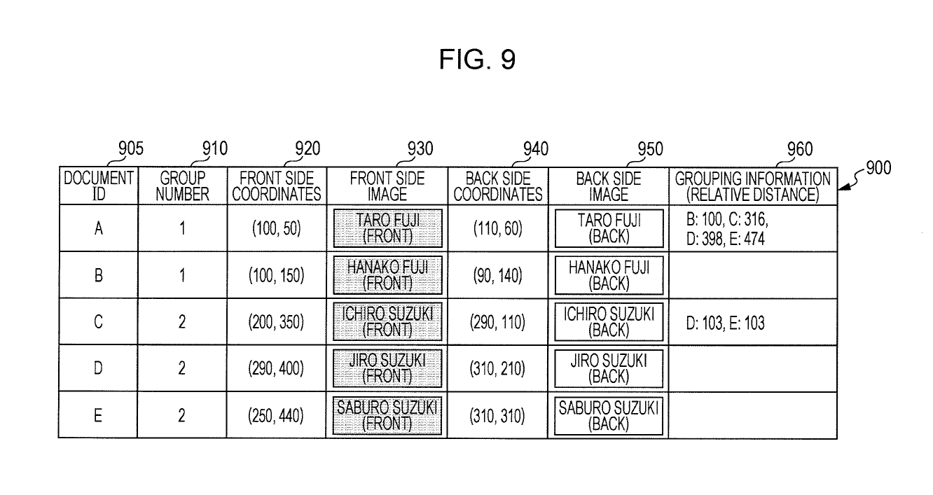

FIG. 9 is an explanatory diagram illustrating an exemplary data structure of a data table 900. The data table 900 includes a document ID field 905, a group number field 910, a front side coordinates field 920, a front side image field 930, a back side coordinates field 940, a back side image field 950, and a grouping information (relative distance) field 960. The document ID field 905 stores an identification code for identifying a pair of document images (the front side image and the back side image of a card image) uniquely in the present exemplary embodiment. The group number field 910 stores a group number of the pair of document images. The front side coordinates field 920 stores the coordinates of the front side image, such as the center coordinates of the front side image, for example. The front side image field 930 stores the front side image. The front side image field 930 may store the front side image itself, or information such as the name of a file storing the front side image. The back side coordinates field 940 stores the coordinates of the back side image, such as the center coordinates of the back side image, for example. The back side image field 950 stores the back side image. The back side image field 950 may store the back side image itself, or information such as the name of a file storing the back side image. The grouping information (relative distance) field 960 stores information (relative distances) utilized in the grouping process.

In the example of FIG. 9, the card image (Taro Fuji (front)) 305 and the card image (Taro Fuji (back)) 375 on the first row of the data table 900, and the card image (Hanako Fuji (front)) 310 and the card image (Hanako Fuji (back)) 380 on the second row, belong to a group 1 (group A315).

The card image (Ichiro Suzuki (front)) 320 and the card image (Ichiro Suzuki (back)) 385 on the third row of the data table 900, the card image (Jiro Suzuki (front)) 325 and the card image (Jiro Suzuki (back)) 390 on the fourth row, and the card image (Saburo Suzuki (front)) 330 and the card image (Saburo Suzuki (back)) 395 on the fifth row belong to a group 2 (group B335).

### <Practical Example of Grouping>

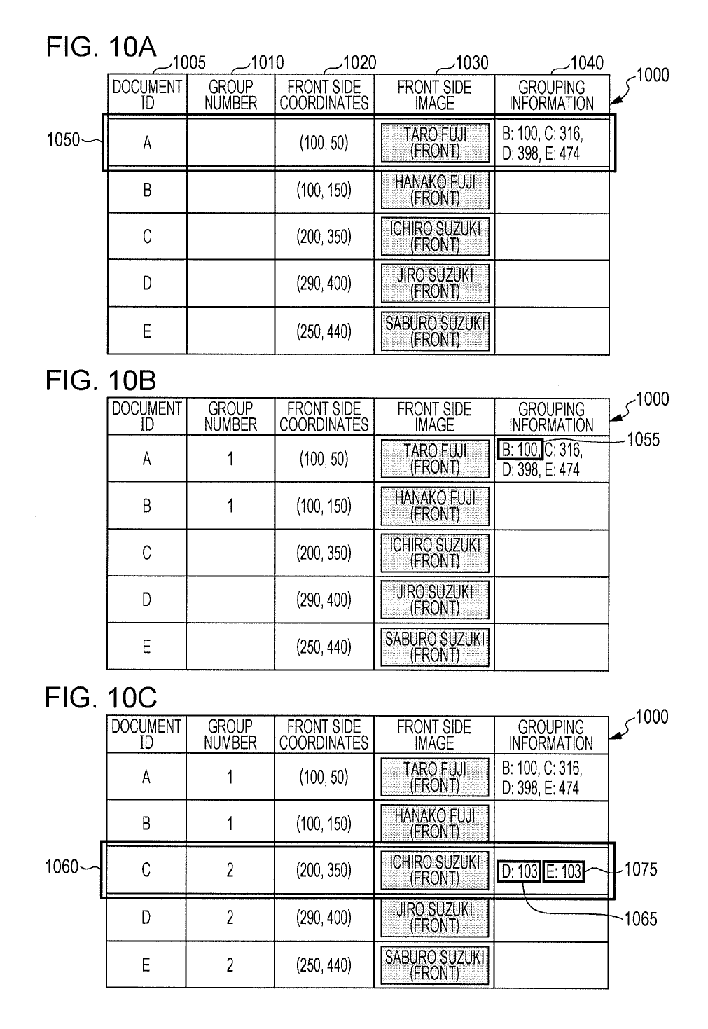

The example of FIGS. 10A to 100 will be used to explain in detail. Note that the data table 1000 is a subset of the data table 900, and the document ID field 1005, the group number field 1010, the front side coordinates field 1020, the front side image field 1030, and the grouping information field 1040 correspond to the document ID field 905, the group number field 910, the front side coordinates field 920, the front side image field 930, and the grouping information (relative distance) field 960, respectively.

(1) The record (processing target 1050) having front side coordinates closest to the origin (for example, the upper-left) is taken to be the target (see FIG. 10A).
(2) Grouping information for the targeted record is acquired. In this example, the distance to the document with the document ID B is “100”, the distance to the document with the document ID C is “316”, the distance to the document with the document ID D is “398”, and the distance to the document with the document ID E is “474” (see FIG. 10A).
(3) Records whose grouping information is included within the group determination distance are determined to be in the same group, and a group number is assigned (see FIG. 10B). The distance to the document with the document ID B is “100” (same group determination basis 1055), which is less than the group determination distance (110 mm).
(4) A record without an assigned group number (processing target 1060) is taken to be the target (see FIG. 10C).
(5) Grouping information is computed, records whose grouping information is included within the group determination distance are determined to be in the same group, and a group number is assigned (see FIG. 10C). The distances to the documents with the document IDs D and E are “103” (same group determination basis 1065) and “103” (same group determination basis 1075), respectively, which are less than the group determination distance (100 mm).

Consequently, the card image (Taro Fuji (front)) 305 and the card image (Hanako Fuji (front)) 310 become a group 1, while the card image (Ichiro Suzuki (front)) 320, the card image (Jiro Suzuki (front)) 325, and the card image (Saburo Suzuki (front)) 330 become a group 2.

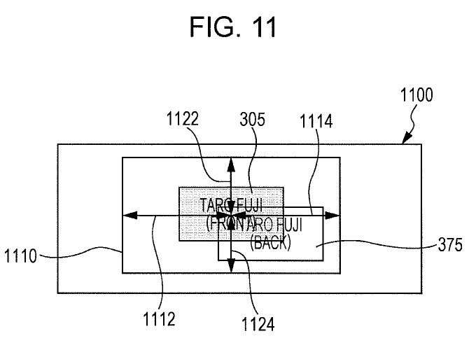

FIG. 11 is an explanatory diagram illustrating an exemplary process by the exemplary embodiment (the front-and-back association processing module 125).

If the card image (Taro Fuji (back)) 375 exists in an association region 1110 within a front-and-back association length (up) 1122 in the upward direction, a front-and-back association length (down) 1124 in the downward direction, a front-and-back association width (left) 1112 in the leftward direction, and a front-and-back association width (right) 1114 in the rightward direction from the center coordinates of the card image (Taro Fuji (front)) 305, the card image (Taro Fuji (back)) 375 is judged to be the back side image of the card image (Taro Fuji (front)) 305.

(1) The absolute coordinates of the documents (the center coordinates of the front side images and the back side images) are extracted from the image of the scan result.
(2) The front-and-back association process is conducted.

If the back side coordinates are within a front-and-back association determination length extending in the positive and negative directions from the x coordinate of the front side coordinates (the front-and-back association width (left) 1112 and the front-and-back association width (right) 1114), and also within a front-and-back association determination width extending in the positive and negative directions from the y coordinate of the front side coordinates (the front-and-back association length (up) 1122 and the front-and-back association length (down) 1124), the back side coordinates are associated with the corresponding front side coordinates, and thus the front side image and the back side image are associated with each other.

This process is for associating the front and back sides of a document even if the position of the document is shifted slightly by the operation of flipping over the document by the user. Since only the center coordinates are referenced, the front-and-back association process does not depend on the grouping process performed using the front sides.

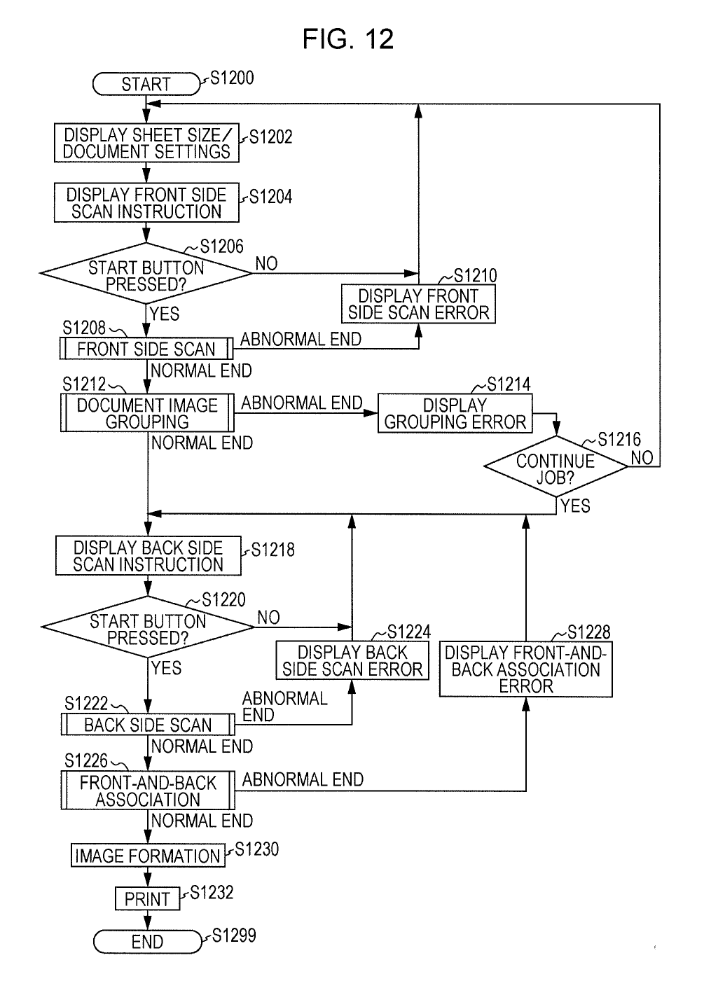

FIG. 12 is a flowchart illustrating an example of a process according to the exemplary embodiment.

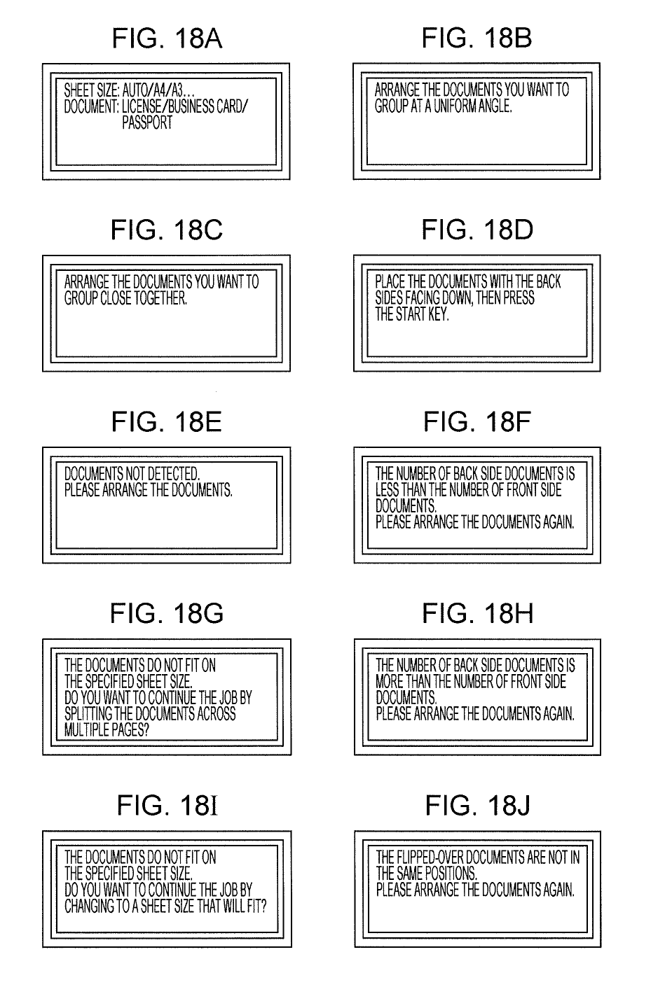

In step S1202, the sheet size/document settings are displayed on-screen. In step S1202, the message illustrated in FIG. 18A is displayed, for example. As the sheet size/document settings display, the message “Sheet size: Auto/A4/A3 . . . , Document: License/Business card/Passport” is displayed, for example.

In step S1204, a front side scan instruction is displayed on-screen. In step S1204, the message illustrated in FIG. 18B or FIG. 18C is displayed, for example. As the front side scan instruction display (angle determination), the message “Arrange the documents you want to group at a uniform angle.” may be displayed, for example. As the front side scan instruction display (distance determination), the message “Arrange the documents you want to group close together.” may be displayed, for example.

In step S1206, it is determined whether or not the Start button is pressed, and if pressed, the flow proceeds to step S1208. Otherwise, the flow returns to step S1202.

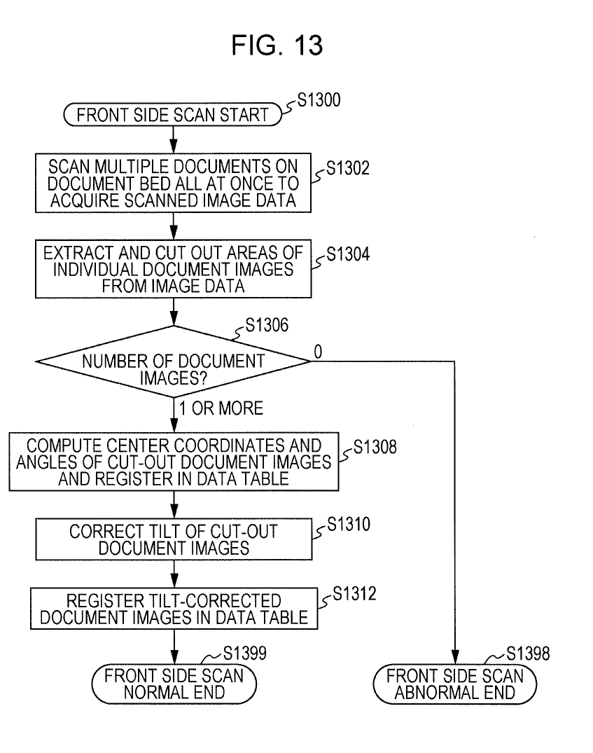

In step S1208, the front sides are scanned. Details of the process in step S1208 will be discussed later using the flowchart illustrated by the example of FIG. 13. If the process of step S1208 ends normally, the flow proceeds to step S1212, whereas if the process of step S1208 ends abnormally, the flow proceeds to step S1210.

In step S1210, a front side scan error display is presented on-screen, and the flow returns to step S1202. In step S1210, the message illustrated in FIG. 18E is displayed, for example. As the front side scan error display, the message “Documents not detected. Please arrange the documents.” may be displayed, for example.

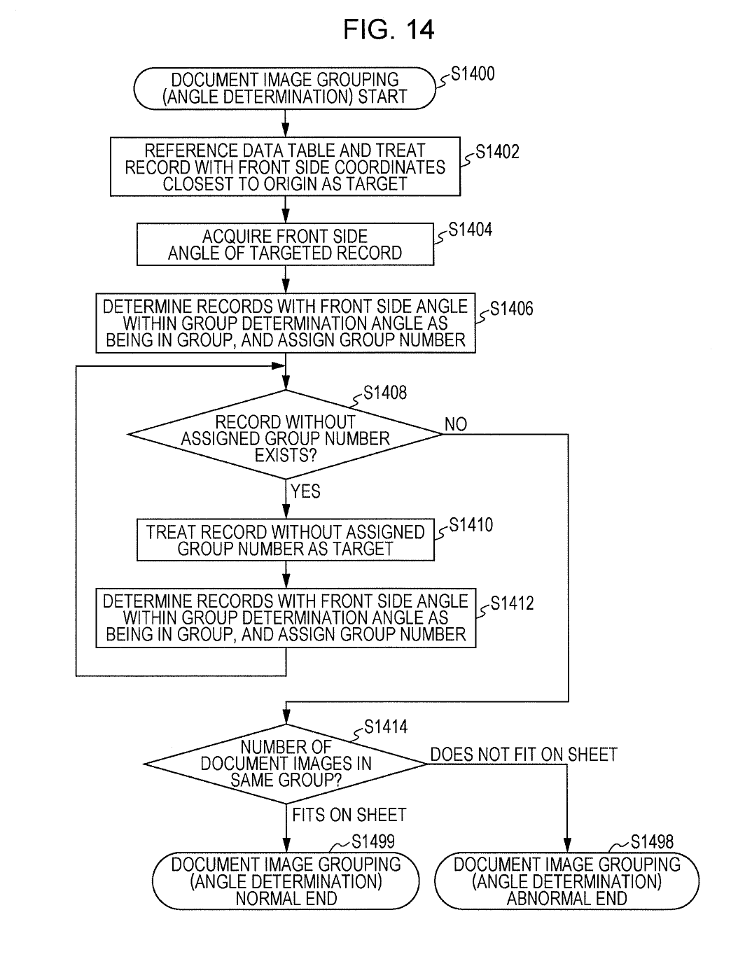

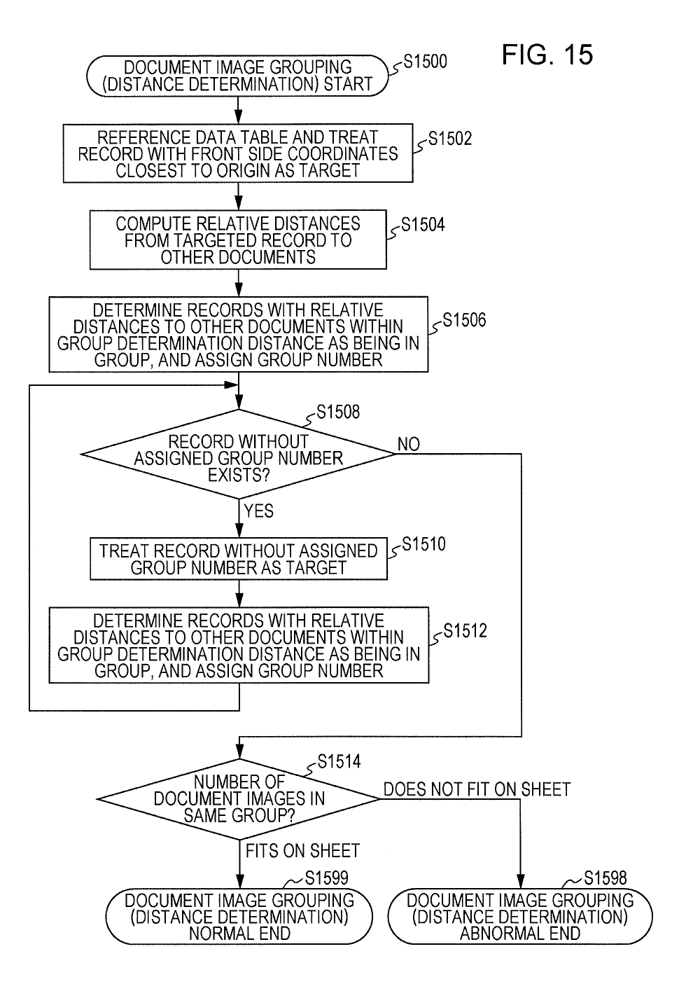

In step S1212, document image grouping is conducted. Details of the process in step S1212 will be discussed later using the flowcharts illustrated by the examples of FIGS. 14 and 15. If the process of step S1212 ends normally, the flow proceeds to step S1218, whereas if the process of step S1212 ends abnormally, the flow proceeds to step S1214.

Note that in step S1212, the flow branches to either (1) the grouping process using angle or (2) the grouping process using distance, according to a grouping algorithm (angle or distance) setting configured as system data.

In step S1214, a grouping error display is presented on-screen. In step S1214, the message illustrated in FIG. 18G or FIG. 18I is displayed, for example. As the grouping error display, the message “The documents do not fit on the specified sheet size. Do you want to continue the job by splitting the documents across multiple pages?” may be displayed, for example. As the grouping error display, the message “The documents do not fit on the specified sheet size. Do you want to continue the job by changing to a sheet size that will fit?” may be displayed, for example.

In step S1216, it is determined whether or not to continue the job (the current process) according to a user operation. In the case of continuing, the flow proceeds to step S1218, otherwise the flow returns to step S1202.

In step S1218, a back side scan instruction display is presented on-screen. In step S1218, the message illustrated in FIG. 18D is displayed, for example. As the back side scan instruction display, the message “Place the documents with the back sides facing down, then press the Start key.” may be displayed, for example.

In step S1220, it is determined whether or not the Start button is pressed, and if pressed, the flow proceeds to step S1222. Otherwise, the flow returns to step S1218.

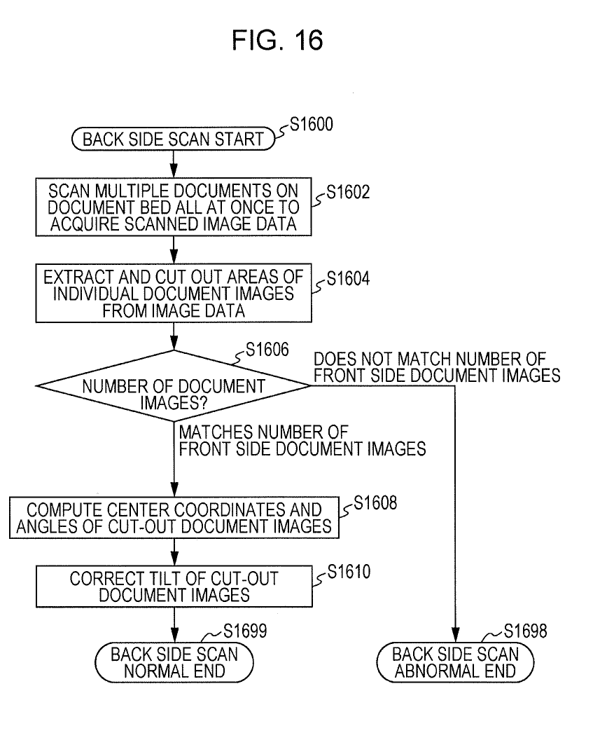

In step S1222, the back sides are scanned. Details of the process in step S1222 will be discussed later using the flowchart illustrated by the example of FIG. 16. If the process of step S1222 ends normally, the flow proceeds to step S1226, whereas if the process of step S1222 ends abnormally, the flow proceeds to step S1224.

In step S1224, a back side scan error display is presented on-screen, and the flow returns to step S1218. In step S1224, the message illustrated in FIG. 18F or FIG. 18H is displayed, for example. As the back side scan error display, the message “The number of back side documents is less than the number of front side documents. Please arrange the documents again.” may be displayed, for example. As the back side scan error display, the message “The number of back side documents is more than the number of front side documents. Please arrange the documents again.” may be displayed, for example.

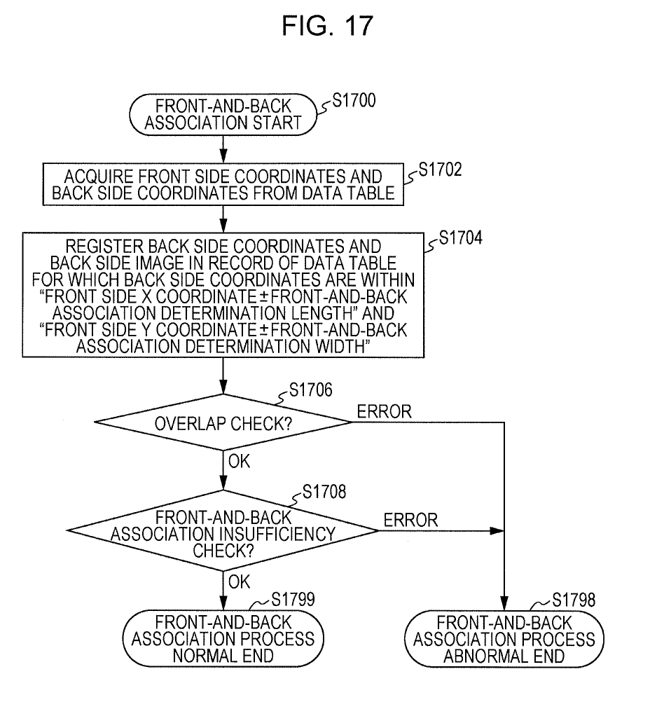

In step S1226, front-and-back association is conducted. Details of the process in step S1226 will be discussed later using the flowchart illustrated by the example of FIG. 17. If the process of step S1226 ends normally, the flow proceeds to step S1230, whereas if the process of step S1226 ends abnormally, the flow proceeds to step S1228.

In step S1228, a front-and-back association error display is presented on-screen, and the flow returns to step S1218. In step S1228, the message illustrated in FIG. 18J is displayed, for example. As the front-and-back association error display, the message “The flipped-over documents are not in the same positions. Please arrange the documents again.” may be displayed, for example.

In step S1230, images are formed. For example, images for printing onto the sheet 400 and the sheet 450 illustrated as an example in FIG. 4 are generated.

In step S1232, the images formed in step S1230 are printed onto sheets.

FIG. 13 is a flowchart illustrating an example of a process according to the exemplary embodiment.

In step S1300, a front side scan is started.

In step S1302, multiple documents on the document bed are scanned all at once to acquire image data.

In step S1304, the regions of individual document images are extracted and cut out from the image data.

In step S1306, the number of document images is determined, and if there are one or more document images, the flow proceeds to step S1308. If there are zero document images, the flow proceeds to “front side scan abnormal end” (step S1398).

In step S1308, the center coordinates and the angles of the cut-out document images are computed and registered in a data table.

In step S1310, the tilt of the cut-out document images is corrected.

In step S1312, the tilt-corrected document images are registered in the data table, and the flow proceeds to “front side scan normal end” (step S1399).

FIG. 14 is a flowchart illustrating an example of a process according to the exemplary embodiment.

In step S1400, document image grouping (angle determination) is started.

In step S1402, the data table is referenced, and the record whose front side coordinates are closest to the origin is taken to be the target.

In step S1404, the front side angle of the targeted record is acquired.

In step S1406, records whose front side angle is included within the group determination angle are determined to be in a group, and a group number is assigned.

In step S1408, it is determined whether or not a record without an assigned group number exists, and if so, the flow proceeds to step S1410. Otherwise, the flow proceeds to step S1414.

In step S1410, a record without an assigned group number is taken to be the target.

In step S1412, records whose front side angle is included within the group determination angle are determined to be in a group, a group number is assigned, and the flow returns to step S1408.

In step S1414, the number of document images in the same group is determined, and if the document images fit within the sheet size, the flow proceeds to “document image grouping (angle determination) normal end” (step S1499), whereas if the document images do not fit within the sheet size, the flow proceeds to “document image grouping (angle determination) abnormal end” (step S1498).

Note that in step S1414, the maximum number of document images that can fit on a sheet is calculated according to (1) the sheet size, and (2) the document set from the user interface.

FIG. 15 is a flowchart illustrating an example of a process according to the exemplary embodiment.

In step S1500, document image grouping (distance determination) is started.

In step S1502, the data table is referenced, and the record whose front side coordinates are closest to the origin is taken to be the target.

In step S1504, the relative distances from the targeted record to the documents are computed.

In step S1506, records whose relative distances to the other documents are within the group determination distance are determined to be in a group, and a group number is assigned.

In step S1508, it is determined whether or not a record without an assigned group number exists, and if so, the flow proceeds to step S1510. Otherwise, the flow proceeds to step S1514.

In step S1510, a record without an assigned group number is taken to be the target.

In step S1512, records whose relative distances to the other documents are included within the group determination distance are determined to be in a group, a group number is assigned, and the flow returns to step S1508.

In step S1514, the number of document images in the same group is determined, and if the document images fit within the sheet size, the flow proceeds to “document image grouping (distance determination) normal end” (step S1599), whereas if the document images do not fit within the sheet size, the flow proceeds to “document image grouping (distance determination) abnormal end” (step S1598).

Note that in step S1514, the maximum number of document images that can fit on a sheet is calculated from (1) the sheet size, and (2) the document set from the user interface.

FIG. 16 is a flowchart illustrating an exemplary process according to the exemplary embodiment.

In step S1600, a back side scan is started.

In step S1602, multiple documents on the document bed are scanned all at once to acquire image data.

In step S1604, the regions of individual document images are extracted and cut out from the image data.

In step S1606, the number of document images is determined, and if the number matches the number of front side images, the flow proceeds to step S1608, whereas if the number does not match the number of front side images, the flow proceeds to “back side scan abnormal end” (step S1698).

Note that in the case of a mismatch in the numbers of document images in step S1606 (that is, the number of front sides is not equal to the number of back sides), it is anticipated that documents were removed or added during the flipping-over operation.

In step S1608, the center coordinates and the angles of the cut-out document images are computed.

In step S1610, the tilt of the cut-out document images is corrected, and the flow proceeds to “back side scan normal end” (step S1699).

FIG. 17 is a flowchart illustrating an example of a process according to the exemplary embodiment.

In step S1700, front-and-back association is started.

In step S1702, the front side coordinates and the back side coordinates are acquired from the data table.

In step S1704, the back side coordinates and the back side image are registered in the data table with a record for which the back side coordinates are within the front-and-back association determination length extending in the positive and negative directions from the x coordinate of the front side coordinates and also within a front-and-back association determination width extending in the positive and negative directions from the y coordinate of the front side coordinates.

In step S1706, an overlap check is performed, and if OK, the flow proceeds to step S1708. In the case of an error, the flow proceeds to “front-and-back association process abnormal end” (step S1798).

Note that in step S1706, it is anticipated that attempting to register to a location already registered in the data table may cause the flipped-over document position to be shifted greatly and intrude into another document position. For this reason, the overlap check is performed.

In step S1708, a front-and-back association insufficiency check is performed, and if OK, the flow proceeds to “front-and-back association process normal end” (step S1799). In the case of an error, the flow proceeds to “front-and-back association process abnormal end” (step S1798).

Note that in step S1708, if a back side image is not detected for a front side image, it is anticipated that the flipped-over document position has shifted greatly, and that the flipped-over document has been arranged at a position where the front side image was not arranged. For this reason, the front-and-back association insufficiency check is performed.

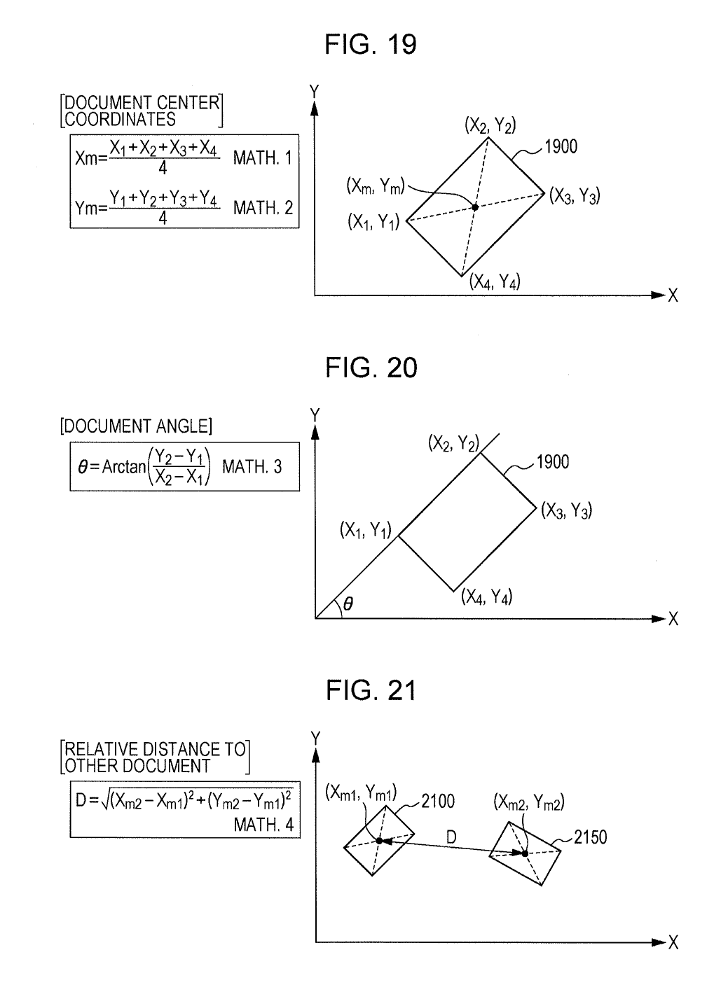

FIG. 19 is an explanatory diagram illustrating an example of a process (an example of a process of extracting the center coordinates of a document image) according to the present exemplary embodiment.

The example illustrated in FIG. 19 demonstrates how, provided that the coordinates of each vertex of a document image 1900 are (X₁, Y₁), (X₂, Y₂), (X₃, Y₃), and (X₄, Y₄), the center coordinates (Xₘ, Yₘ) of the document image 1900 may be computed according to Math. 1 and Math. 2.

$$\begin{matrix}Xm = \frac{{X}_{1} + {X}_{2} + {X}_{3} + {X}_{4}}{4} & ( Math . 1 ) \\ Ym = \frac{{Y}_{1} + {Y}_{2} + {Y}_{3} + {Y}_{4}}{4} & ( Math . 2 )\end{matrix}$$

FIG. 20 is an explanatory diagram illustrating an example of a process (an example of a process of extracting the angle of a document image) according to the present exemplary embodiment.

The example illustrated in FIG. 20 demonstrates how the angle (tilt) of the document image 1900 may be computed according to Math. 3.

$$θ = Arctan ( \frac{{Y}_{2} - {Y}_{1}}{{X}_{2} - {X}_{1}} ) \qquad ( Math . 3 )$$

FIG. 21 is an explanatory diagram illustrating an example of a process (an example of a process of extracting the distance to another document image) according to the present exemplary embodiment.

The example illustrated in FIG. 21 demonstrates how, provided that the center coordinates of a document image 2100 are (Xₘ₁, Yₘ₁) and the center coordinates of a document image 2150 are (Xₘ₂, Yₘ₂), the relative distance between the document image 2100 and the document image 2150 may be computed according to Math. 4.

D=\sqrt{(Xₘ₂−Xₘ₁)²+(Yₘ₂−Yₘ₁)²} (Math. 4)

Next, an example of a process will be illustrated for a case in which a display capable of displaying images (which may also be thumbnail images (reduced images)) is included as the user interface unit 230 (that is, a case in which what is called a rich UI is included).

### <1> Example of Grouping Process Using Angle

Before the processing, the following system data is set.

a) For the grouping algorithm (angle or distance), “angle” is set.
b) For the group determination angle (for example, a value within a range from 5° to 10° is preferable), 5° is adopted, for example.
c) For the front-and-back association determination length (for example, if the document is a license, a value within a range from 80 mm to 99 mm is preferable), 85 mm is adopted, for example.
d) For the front-and-back association determination width (for example, if the document is a license, a value within a range from 50 mm to 60 mm is preferable), 55 mm is adopted, for example.
(1) It is detected that the operator presses an “ID Card Copy” button on the user interface unit 230.
(2) A sheet size/document size settings screen is displayed on the display, and it is detected that the operator performs operations that set the sheet size to A4, and set the document to license.
(3) An instruction to arrange at a uniform angle the licenses that the operator wants to group is displayed on the display, and the operator arranges three licenses (the respective licenses of Taro Sato, Hanako Sato, and Ichiro Sato) horizontally, arranges another two (the respective licenses of Hiroshi Takahashi and Hana Takahashi) vertically, and arranges another three (Takashi Tanaka, Ume Tanaka, Sakura Tanaka) tilted diagonally (45°).
(4) It is detected that the operator presses a Start button.
(5) An instruction to flip over the documents is displayed on the display, and the operator flips over the documents in place. Subsequently, it is detected that the operator presses the Start button.
(6) Print image thumbnails are displayed.

The grouping process using the angles of the documents and the process of associating the front sides with the back sides are conducted, and print image thumbnails are displayed.

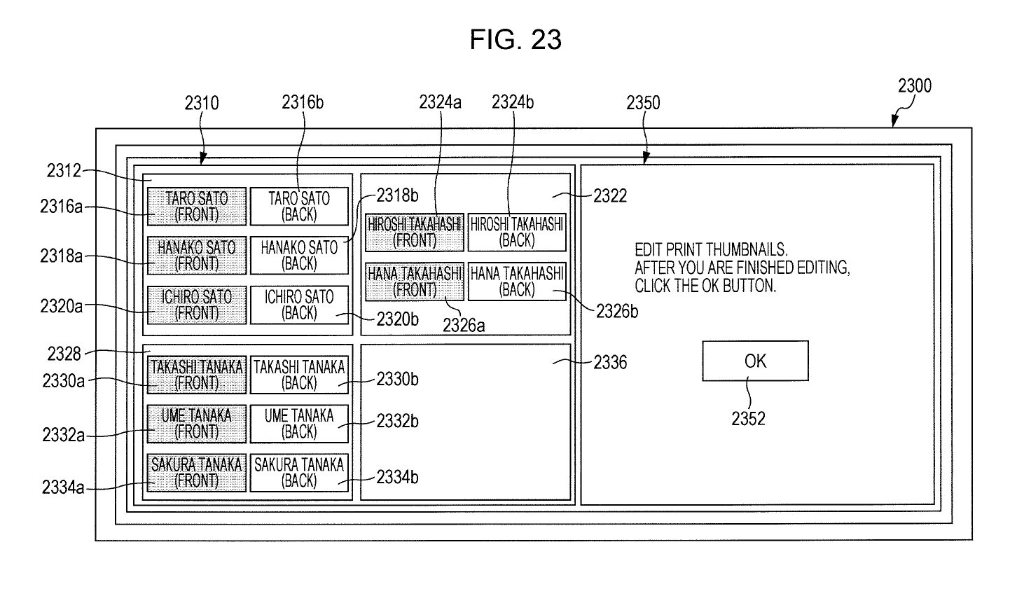

For example, as illustrated in FIG. 23, a print thumbnail screen 2310 and a message & button screen 2350 are displayed on a screen 2300.

On the print thumbnail screen 2310, a print sheet thumbnail 2312, a print sheet thumbnail 2322, a print sheet thumbnail 2328, and a print sheet thumbnail 2336 are displayed. The message & button screen 2350 includes an “OK” button 2352, and displays the message “Edit print thumbnails. After you are finished editing, click the OK button.”, for example.

The card image (Taro Sato (front)) 2316a and the card image (Taro Sato (back)) 2316b, the card image (Hanako Sato (front)) 2318a and the card image (Hanako Sato (back)) 2318b, and the card image (Ichiro Sato (front)) 2320a and the card image (Ichiro Sato (back)) 2320b are respective pairs. Additionally, the card images (Taro Sato) 2316, the card images (Hanako Sato) 2318, and the card images (Ichiro Sato) 2320 are in the same group, and thus are arranged on the print sheet thumbnail 2312.

The card image (Hiroshi Takahashi (front)) 2324a and the card image (Hiroshi Takahashi (back)) 2324b, and the card image (Hana Takahashi (front)) 2326a and the card image (Hana Takahashi (back)) 2326b, are respective pairs. Additionally, the card images (Hiroshi Takahashi) 2324 and the card images (Hana Takahashi) 2326 are in the same group, and thus are arranged on the print sheet thumbnail 2322.

The card image (Takashi Tanaka (front)) 2330a and the card image (Takashi Tanaka (back)) 2330b, the card image (Ume Tanaka (front)) 2332a and the card image (Ume Tanaka (back)) 2332b, and the card image (Sakura Tanaka (front)) 2334a and the card image (Sakura Tanaka (back)) 2334b are respective pairs. Additionally, the card images (Takashi Tanaka) 2330, the card images (Ume Tanaka) 2332, and the card images (Sakura Tanaka) 2334 are in the same group, and thus are arranged on the print sheet thumbnail 2328.

In other words, a print sheet thumbnail 2312 displaying the fronts and backs of three licenses (the respective licenses of Taro Sato, Hanako Sato, and Ichiro Sato), a print sheet thumbnail 2322 displaying the fronts and backs of another two licenses (the respective licenses of Hiroshi Takahashi and Hana Takahashi), and a print sheet thumbnail 2328 displaying the fronts and backs of another three licenses (the respective licenses of Takashi Tanaka, Ume Tanaka, and Sakura Tanaka) are displayed on the print thumbnail screen 2310 as respectively different images.

(7) Pairs of document images on the print thumbnail screen 2310 are moved onto other sheets as single entities, it is detected that the “OK” button 2352 on the message & button screen 2350 is tapped, and the editing of the print thumbnails is ended. For example, the above occurs when there is a mistake in the grouping process, or when the operator misarranged the documents. In the example herein, after the screen 2300 is displayed, the operator realizes that Ichiro Sato and Sakura Tanaka are married, and putting the license images for these two people in the same group is appropriate.

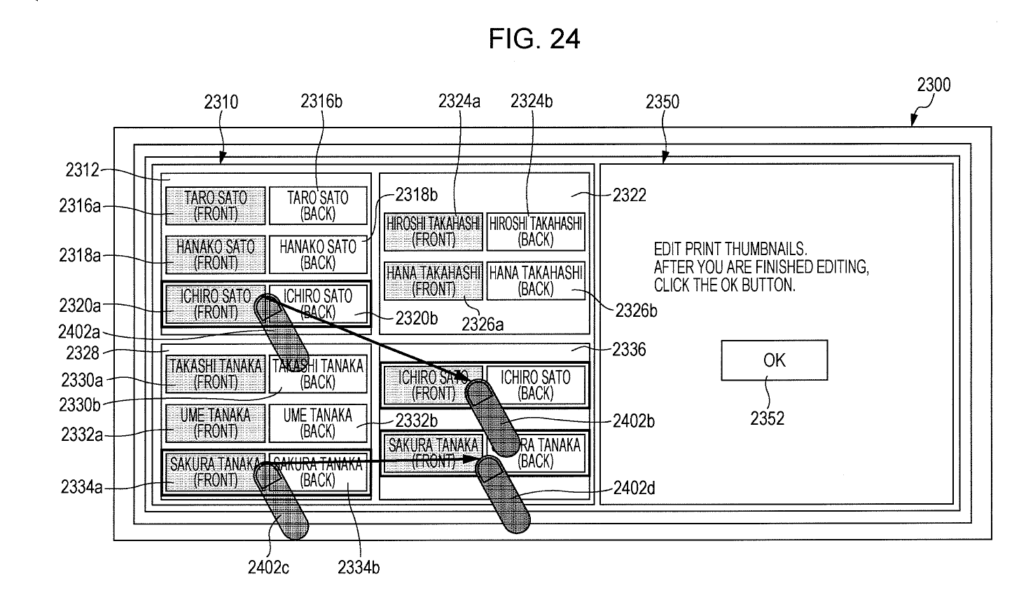

For example, as illustrated in FIG. 24, document images (a front-and-back pair) is moved to another sheet with a swipe or a flick from the position of the finger 2402a to the position of the finger 2402b. In this example, the pair of the card image (Ichiro Sato (front)) 2320a and the card image (Ichiro Sato (back)) 2320b is moved from the print sheet thumbnail 2312 to the print sheet thumbnail 2336.

In addition, document images (a front-and-back pair) is moved to another sheet with a swipe or a flick from the position of the finger 2402c to the position of the finger 2402d. In this example, the pair of the card image (Sakura Tanaka (front)) 2334a and the card image (Sakura Tanaka (back)) 2334b is moved from the print sheet thumbnail 2328 to the print sheet thumbnail 2336.

Note that the finger 2402a and the finger 2402c is also able to move document images (a front-and-back pair) to another sheet with a long tap or a double tap.

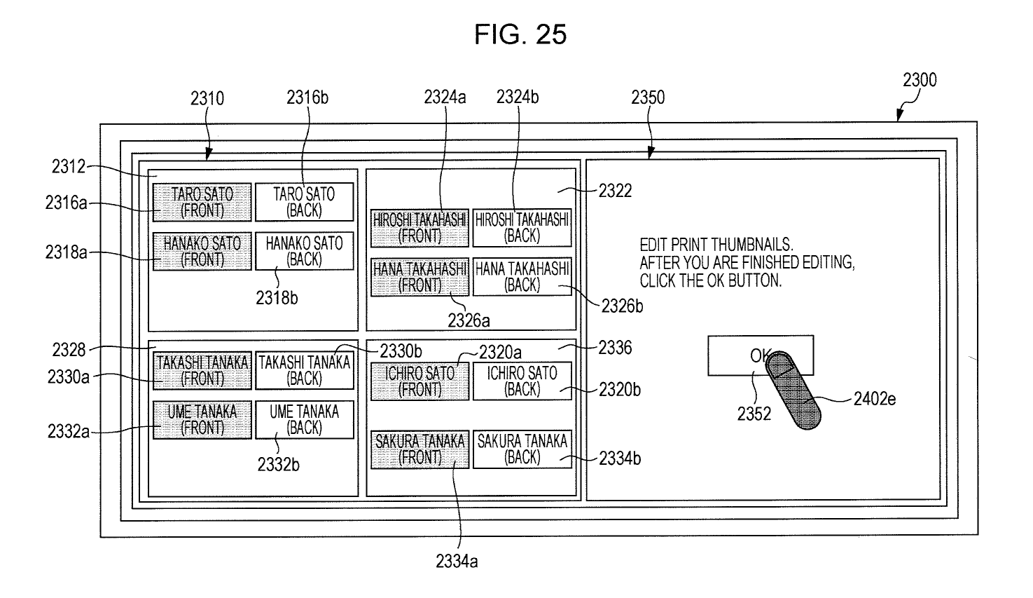

Subsequently, the print thumbnail screen 2310 like the one illustrated by the example of FIG. 25 is displayed. Additionally, after the editing of the print layout is finished, the “OK” button 2352 is tapped with a finger 2402e.

(8) Printing is started.
(9) The printed results of the fronts and backs of two licenses (the respective licenses of Taro Fuji and Hanako Fuji), the fronts and backs of two licenses (the respective licenses of Hiroshi Takahashi and Hana Takahashi), and the fronts and backs of two licenses (the respective licenses of Ichiro Sato and Sakura Tanaka) are obtained on respectively separate sheets.

<2> Example of Grouping Process Using Distance

Before the processing, the following system data is set.

a) For the grouping algorithm (angle or distance), “distance” is set.
b) For the group determination distance (for example, if the document is a license, a value from 110 mm to 120 mm is preferable), 110 mm is adopted, for example.
c) For the front-and-back association determination length (for example, if the document is a license, a value from 80 mm to 90 mm is preferable), 85 mm is adopted, for example.
d) For the front-and-back association determination width (for example, if the document is a license, a value from 50 mm to 60 mm is preferable), 55 mm is adopted, for example.
(1) It is detected that the operator presses an “ID Card Copy” button on the user interface unit 230.
(2) A sheet size/document size settings screen is displayed on the display, and it is detected that the operator performs operations that set the sheet size to A4, and set the document to license.
(3) An instruction to arrange closely the licenses that the operator wants to group is displayed on the display, and the operator arranges closely three licenses (the respective licenses of Taro Sato, Hanako Sato, and Ichiro Sato), arranges closely another two (the respective licenses of Hiroshi Takahashi and Hana Takahashi), and arranges closely another three (Takashi Tanaka, Ume Tanaka, Sakura Tanaka).
(4) It is detected that the operator presses a Start button.
(5) An instruction to flip over the documents is displayed on the display, and the operator flips over the documents in place. Subsequently, it is detected that the operator presses the Start button.
(6) Print image thumbnails are displayed.

The grouping process using the distances between the documents and the process of associating the front sides with the back sides are conducted, and print image thumbnails are displayed.

For example, as illustrated in FIG. 23, the print thumbnail screen 2310 and the message & button screen 2350 are displayed on the screen 2300 as discussed earlier.

(7) Pairs of document images on the print thumbnail screen 2310 are moved onto other sheets as single entities, it is detected that the “OK” button 2352 on the message & button screen 2350 is tapped, and the editing of the print thumbnails is ended.

For example, as illustrated in FIGS. 24 and 25, editing is performed on the print thumbnail screen 2310 as discussed earlier.

(8) Printing is started.
(9) The printed results of the fronts and backs of two licenses (the respective licenses of Taro Fuji and Hanako Fuji), the fronts and backs of two licenses (the respective licenses of Hiroshi Takahashi and Hana Takahashi), and the fronts and backs of two licenses (the respective licenses of Ichiro Sato and Sakura Tanaka) are obtained on respectively separate sheets.

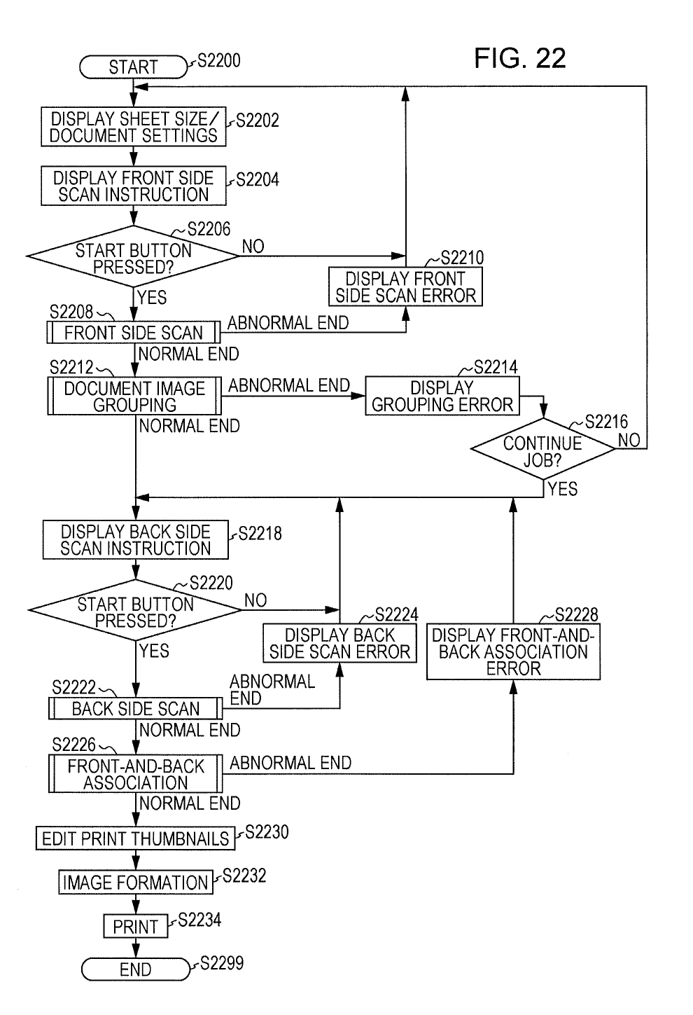

FIG. 22 is a flowchart illustrating an example of a process according to the exemplary embodiment. The flowchart illustrated by the example of FIG. 22 is similar to the flowchart illustrated by the example in FIG. 12, with the addition of step S2230. The processes in the other steps are similar to the processes in the steps of the flowchart illustrated by the example of FIG. 12.

In step S2202, the sheet size/document settings are displayed.

In step S2204, a front side scan instruction is displayed.

In step S2206, it is determined whether or not the Start button is pressed, and if pressed, the flow proceeds to step S2208. Otherwise, the flow returns to step S2202.

In step S2208, the front sides are scanned. If the process of step S2208 ends normally, the flow proceeds to step S2212, whereas if the process of step S2208 ends abnormally, the flow proceeds to step S2210.

In step S2210, a front side scan error display is presented, and the flow returns to step S2202.

In step S2212, document image grouping is conducted. If the process of step S2212 ends normally, the flow proceeds to step S2218, whereas if the process of step S2212 ends abnormally, the flow proceeds to step S2214.

In step S2214, a grouping error display is presented.

In step S2216, it is determined whether or not to continue the job, and in the case of continuing, the flow proceeds to step S2218. Otherwise, the flow returns to step S2202.

In step S2218, a back side scan instruction display is presented.

In step S2220, it is determined whether or not the Start button is pressed, and if pressed, the flow proceeds to step S2222. Otherwise, the flow returns to step S2218.

In step S2222, the back sides are scanned. If the process of step S2222 ends normally, the flow proceeds to step S2226, whereas if the process of step S2222 ends abnormally, the flow proceeds to step S2224.

In step S2224, a back side scan error display is presented, and the flow returns to step S2218.

In step S2226, front-and-back association is conducted. If the process of step S2226 ends normally, the flow proceeds to step S2230, whereas if the process of step S2226 ends abnormally, the flow proceeds to step S2228.

In step S2228, a front-and-back association error display is presented, and the flow returns to step S2218.

In step S2230, print thumbnails are edited.

In step S2232, images are formed.

In step S2234, printing is conducted.

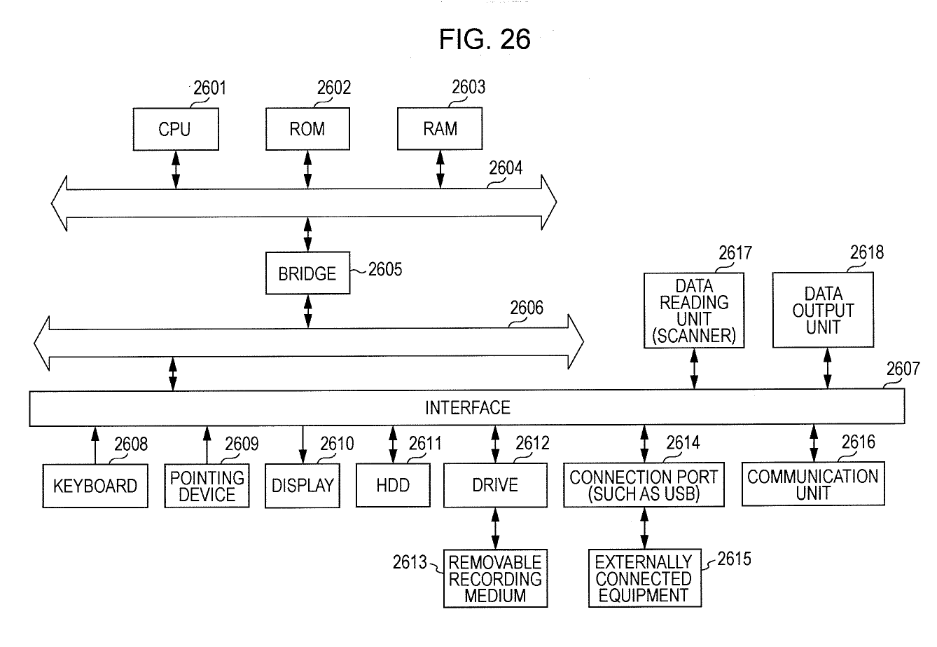

An exemplary hardware configuration of an image processing device according to an exemplary embodiment will now be described with reference to FIG. 26. The configuration illustrated in FIG. 26 may be realized by a personal computer (PC), for example, and illustrates an exemplary hardware configuration equipped with a data reading unit 2617 such as a scanner, and a data output unit 2618 such as a printer.

The central processing unit (CPU) 2601 is a controller that executes processing according to a computer program that states execution sequences for the various modules described in the foregoing exemplary embodiment, or in other words, for respective modules such as the first image reception module 105, the second image reception module 110, the image preprocessing module 115, the grouping processing module 120, the front-and-back association processing module 125, the image generation module 130, the print module 135, the document feeding control module 215, the reading control module 225, the user interface control module 235, the central control module 245, the image processing module 255, the edge recognition module 260, the edge extraction module 265, the image correction module 275, the image forming control module 285, the sheet housing module 292, and the sheet transport module 294.

The read-only memory (ROM) 2602 stores information such as programs and computational parameters used by the CPU 2601. The random access memory (RAM) 2603 stores information such as programs used during execution by the CPU 2601, and parameters that change as appropriate during such execution. These memory units are connected to each other by a host bus 2604 realized by a CPU bus, for example.

The host bus 2604 is connected to an external bus 2606 such as a Peripheral Component Interconnect/Interface (PCI) bus via the bridge 2605.

The keyboard 2608 and the mouse or other pointing device 2609 are devices operated by a user. The display 2610 may be a liquid crystal display (LCD) or cathode ray tube (CRT) device, and displays various information as text and image information. Additionally, a device such as a touchscreen equipped with the functions of both the pointing device 2609 and the display 2610 is also acceptable.

The hard disk drive (HDD) 2611 houses and drives a hard disk (which may also be flash memory or the like), causing programs executed by the CPU 2601 and information to be recorded thereto or retrieved therefrom. Information such as images and the processing results of respective modules is stored on the hard disk. Additionally, information such as various other data and various computer programs are stored therein.

The drive 2612 reads out data or programs recorded onto a removable recording medium 2613 such as an inserted magnetic disk, optical disc, magneto-optical disc, or semiconductor memory, and supplies the data or programs to the RAM 2603 connected via the interface 2607, the external bus 2606, the bridge 2605, and the host bus 2604. Note that the removable recording medium 2613 is also usable as a data recording area.

The connection port 2614 is a port that connects to externally connected equipment 2615, and has a USB, IEEE 1394, or similar receptacle. The connection port 2614 is connected to the CPU 2601 via the interface 2607, the external bus 2606, the bridge 2605, and the host bus 2604. The communication unit 2616 is connected to a communication link and executes data communication processing with external equipment. The data reading unit 2617 may be a scanner, for example, and executes document scanning processing. The data output unit 2618 may be a printer, for example, and executes document data output processing.

Note that the hardware configuration of an image processing device illustrated in FIG. 26 illustrates a single exemplary configuration, and that the exemplary embodiment is not limited to the configuration illustrated in FIG. 26 insofar as the configuration still enables execution of the modules described in the exemplary embodiment. For example, some modules may also be realized with special-purpose hardware (such as an application-specific integrated circuit (ASIC), for example), and some modules may be configured to reside within an external system and be connected via a communication link. Furthermore, it may also be configured such that multiple instances of the system illustrated in FIG. 26 are connected to each other by a communication link and operate in conjunction with each other.

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), the Internet, an intranet, an extranet, or some combination thereof, or alternatively, by being modulated onto a carrier wave and propagated.

Furthermore, the above program may be part or all of another program, or be recorded to a recording medium together with other separate programs. The above program may also be recorded in a split manner across multiple recording media. The above program may also be recorded in a compressed, encrypted, or any other recoverable form.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing device comprising:
a classification unit that classifies a plurality of a first document image or a plurality of a second document image in accordance with an arrangement of documents; and
a generation unit that generates an image in accordance with a result of the classification.

2. The image processing device according to claim 1, further comprising:
an association unit that associates the first document image with a second document image, the second image being an image of a reverse side of the first document image, wherein
the generation unit generates an image in accordance with the result of the classification and a result of the association.

3. The image processing device according to claim 1, further comprising:
a first extraction unit that extracts a plurality of the first document image from a first image; and
a second extraction unit that extracts a plurality of the second document image from a second image obtained by reading the reverse sides of the plurality of the first document image.

4. The image processing device according to claim 1, further comprising:
a distance extraction unit that extracts distances between document images for the plurality of the first document image or the plurality of the second document image, wherein
the classification unit conducts a classification process that treats the distances between document images as the arrangement.

5. The image processing device according to claim 1, further comprising:
an angle extraction unit that extracts a tilt angle of the plurality of the first document image or the plurality of the second document image, wherein
the classification unit conducts a classification process that treats the tilt angle as the arrangement.

6. The image processing device according to claim 2, wherein
the generation unit arranges the second document image next to the associated first document image, so that document images in the same class are printed on the same sheet.

7. The image processing device according to claim 1, further comprising:
a display that displays the image generated by the generation unit; and
a modification unit that treats a combination of a first image and a second image in the displayed image as a single entity, and modifies a position of the combination in accordance with an operation by an operator.

8. An image processing method comprising:
classifying a plurality of a first document image or a plurality of a second document image in accordance with an arrangement of documents; and
generating an image in accordance with a result of the classifying.

9. A non-transitory computer readable medium storing a program causing a computer to execute a process for image processing, the process comprising:
classifying a plurality of a first document image or a plurality of a second document image in accordance with an arrangement of documents; and
generating an image in accordance with a result of the classifying.
